(19) United States
(12) Patent Application Publication
(10) Pub. No.: US 2017/0029556 A1
(43) Pub. Date: Feb. 2, 2017

(54) EPOXY RESIN COMPOSITION

(71) Applicant: BLUE CUBE IP LLC, Midland, MI (US)

(72) Inventors: Yue Shen, Shanghai (CN); Fu Zhan, Shanghai (CN); Yan Wu, Shanghai (CN); Ray E. Drumright, Midland, MI (US)

(21) Appl. No.: 15/106,916

(22) PCT Filed: Dec. 23, 2013
(86) PCT No.: PCT/CN2013/090195

§ 371 Date: Jun. 21, 2016

(51) Int. Cl. C08G 59/32; C08G 59/50; C08G 59/68; C09D 163/00

(52) U.S. Cl. CPC C08G 59/3218; C09D 163/00; C08G 59/5073; C08G 59/688

(57) ABSTRACT

An epoxy resin composition having desirable drying time and capable of providing coating films with satisfactory weathering resistance, good adhesion to an epoxy primer coat and good flexibility, and high impact strength; a process for preparing the epoxy resin composition; and a curable coating composition comprising the epoxy resin composition.

### FIELD OF THE INVENTION

The present invention relates to an epoxy resin composition. The present invention also relates to a process of preparing the epoxy resin composition, and a curable coating composition comprising the same.

### INTRODUCTION

Epoxy resins are widely used in coating applications such as maintenance and protective coatings (M&PC). Multilayer coating systems generally comprise a topcoat and a primer coat, where the primer coat resides between a substrate being coated and the topcoat. Aromatic epoxy resins such as bisphenol A epoxy resins are widely used as primers, due to their satisfactory adhesion-to-metal strength and chemical resistance. However, coating films made from coating compositions based on aromatic epoxy resins suffer from chalking upon exposure to the elements such as sunlight. Thus, such aromatic epoxy resin-based coating compositions are not suitable for preparing topcoats, which require weathering resistance (also known as weather durability or weatherability).

Currently, widely used topcoats are made from aliphatic polyurethane (PU) coating compositions, since PU has better weathering resistance than aromatic epoxy resins. However, compared to an epoxy topcoat, a PU topcoat can interact negatively with an epoxy primer coat, especially when primer and topcoat compositions are applied and/or cured at low temperature (for example, lower than 5° C.) during the winter season. Such negative interactions may result in poor adhesion between a PU topcoat and an epoxy primer coat, potentially causing the PU topcoat to detach from the epoxy primer coat.

Attempts have been made to increase weathering resistance of epoxy resins. For example, one approach is hydrogenation of aromatic rings in aromatic epoxy resins in the presence of a ruthenium-containing catalyst. Unfortunately, aromatic rings in the aromatic epoxy resins are difficult to completely hydrogenate. Thus, the resultant products may still contain residual unsaturation, resulting in unsatisfactory weathering resistance of topcoats. Moreover, epoxy resins suitable for producing topcoats need to have sufficient reactivity, so that a coating composition comprising the epoxy resins can be dried and cured quickly. For example, M&PC applications typically require a tack-free time of less than 5 hours at ambient temperature (for example, from 20° C. to 25° C.), as determined by the ASTM D 5895 method. Additionally, sufficient flexibility and impact resistance are desirable properties for topcoats to enable the coating to maintain its integrity from deflection and/or bumping.

Therefore, it is desirable to provide an epoxy resin composition suitable for topcoat applications that is free from the challenges associated with conventional aromatic epoxy resin compositions. It is also desirable to provide an epoxy resin coating composition with the previously stated tack-free time that meets industry requirements.

### SUMMARY OF THE INVENTION

The novel epoxy resin composition of the present invention surprisingly provides a curable coating composition that achieves a tack-free time of 5 hours or less at ambient temperature, as determined by the ASTM D 5895 method. At the same time, a coating film made from this curable coating composition shows satisfactory weathering resistance, for example, gloss retention of at least 70% and b value change less than 1.5 after at least 450 hours of testing according to the ASTM G154-06 method. The curable coating composition of the present invention also provides a coating film with better adhesion to an epoxy primer coat than incumbent PU topcoats do, even when primer and topcoat compositions are applied and/or cured at 5° C. or lower.

### DETAILED DESCRIPTION OF THE INVENTION

The epoxy resin composition of the present invention comprises at least one epoxy resin having the following Formula (I):

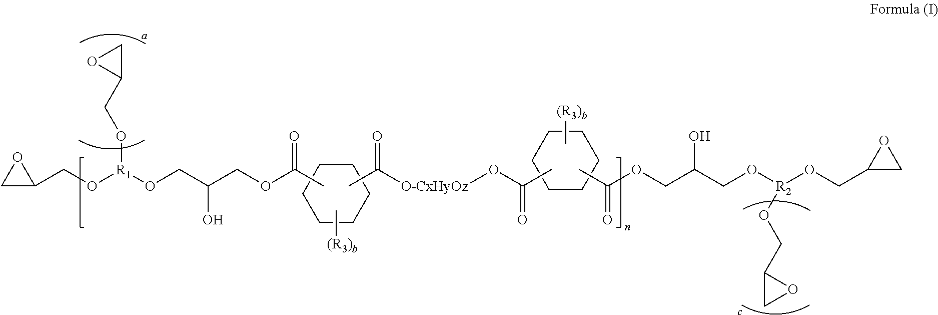

wherein x is an integer from 2 to 15; y is an integer from 4 to 30; z is 0 or 1; a is an integer from 0 to 2, and preferably 11; c is an integer from 0 to 2, and preferably 1; provided that a+c≠0; b is an integer from 0 to 4; R₁ and R₂ each is independently a saturated C₂ to C₂₀ aliphatic hydrocarbon group, a saturated C₅ to C₂₀ cycloaliphatic hydrocarbon group, or combinations thereof; R₃ is a C₁ to C₆ alkyl group; and n is integer from 1 to 60.

“Hydrocarbon group” in the present invention refers to a structure consisting of only hydrogen and carbon atoms. R₁ and R₂ each may be independently derived from alkyl alcohols, cycloaliphatic alcohols, or mixtures thereof.

In some embodiments, R₁ and R₂ each can be independently a saturated aliphatic hydrocarbon group having a structure of Cₘ¹Hₘ², wherein m¹ is an integer of 2 or higher, 4 or higher, or even 6 or higher, and at the same time, 20 or lower, 10 or lower, or even 8 or lower; and m² can be (2 m¹-a) for R₁ group, or (2 m¹-c) for R₂ group, respectively, wherein a and c are as previously defined.

In some other embodiments, R₁ and R₂ each may independently comprise one or two cyclic rings, preferably at least one cyclohexane ring. R₁ or R₂ can be a saturated cycloaliphatic group having a structure of CₚH_{q}, where p can be an integer from 5 to 20. In particular, when R₁ and R₂ each independently contains one cyclic ring, p can be 5 or higher, 6 or higher, and at the same time, 15 or lower, 10 or lower, or even 9 or lower. When R₁ and R₂ each independently contains two cyclic rings, p can be 7 or higher, and at the same time, 20 or lower, or even 15 or lower. q in the above structure is defined as follows:

For R₁ group, q can be 2p-2-a when R₁ contains one cyclic ring, or 2p-4-a when R₁ contains two cyclic rings, wherein a is as previously defined;

For R₂ group, q can be 2p-2-c when R₂ contains one cyclic ring, or 2p-4-c when R₂ contains two cyclic rings, wherein c is as previously defined.

In some preferred embodiments, R₁ and R₂ each can be independently a trivalent group such as

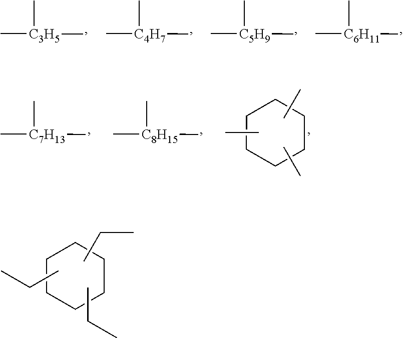

or mixtures thereof; a tetravalent group such as

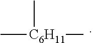

or mixtures thereof; or a combination of one or more trivalent groups and one or more tetravalent groups. In a preferred embodiment, R₁ and R₂ each can be

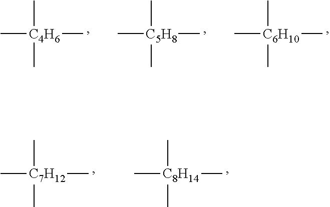

In some preferred embodiments, one of R₁ and R₂ groups is a trivalent, a tetravalent group, or a mixture thereof; and the other one of R₁ and R₂ groups is a divalent group or a combination of different divalent groups. Examples of such divalent groups include a linear Or branched —C₂H₄—, —C₃H₆—, —C₄H₈—, —O₅H₁₀—, —C₆H₁₂—, —C₇H₁₄—, or —C₈H₁₆— group;

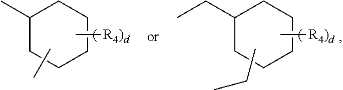

wherein R₄ can be an alkyl group, and preferably a C₁ to C₆ alkyl group, and d can be an integer from 0 to 4; or combinations thereof. Preferred divalent groups include propylene, 2-methylpropylene, neopentylene, 2-butyl-2-ethylpropylene, n-butylene group,

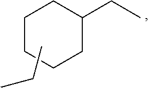

4,4′-(propane-2,2-diyl) dicyclohexyl, cyclohexylene, 1,2-cyclohexanedimethylene, 1,3-cyclohexanedimethylene, 1,4-cyclohexanedimethylene group, or combinations thereof. Preferably, R₁ and R₂ each is independently a combination of the trivalent group and the divalent group described above.

In a preferred embodiment, R₁ and R₇ each is independently selected from

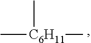

or a combination of

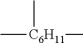

with a divalent group selected from —C₄H₈—, 1,2-cyclohexanedimethylene, 1,3-cyclohexanedimethylene, 1,4-cyclohexanedimethylene, cyclohexylene, or mixtures thereof.

In the —CₓH_{y}O_{z}— group in Formula (I), x can be an integer of 2 or higher, 3 or higher, 4 or higher, or even 5 or higher, and at the same time, 15 or lower, 12 or lower, 10 or lower, or even 9 or lower; y can be an integer of 4 or higher, 6 or higher, or even 8 or higher, and at the same time, 30 or lower, 24 or lower, or even 20 or lower; and z can be 0 or 1. In some embodiments, the —CₓH_{y}O_{z}— group can be a divalent group containing saturated C₂-C₂₀ aliphatic hydrocarbon unit, a saturated C₅-C₂₀ cycloaliphatic hydrocarbon unit, or combinations thereof. The —CₓH_{y}O_{z}— group can be a group selected from those divalent R₁ or R₂ groups described above. In some preferred embodiments, z is 0, and —CₓH_{y}O_{z}— is a C₆ to C₁₀ cycloalkylene group, a C₂ to C₉ aliphatic hydrocarbon group, or a mixture thereof; and more preferably a C₆ to C₁₀ cycloalkylene group. In a more preferred embodiment, the —CₓH_{y}O_{z}— group is selected from a linear or branched —C₂H₄—, —C₃H₆—, —C₄H₈—, —CH₂CH₂—O—CH₂CH₂—, —O₅H₁₀—, —C₆H₁₂— or —C₉H₁₈—; 1,2-cyclohexanedimethylene; 1,3-cyclohexanedimethylene; 1,4-cyclohexanedimethylene; cyclohexylene; or mixtures thereof.

b can be 0, 1, 2, 3 or 4, and preferably 0 or 1; and R₃ is preferably —CH₃.

n can be 1 or higher, 2 or higher, or even 3 or higher, and at the same time, 60 or lower, 30 or lower, or even 10 or lower. When n is 2 or higher, each R₁, —CₓH_{y}O_{z}— group, or R₃ if present, respectively, in repeating units of Formula (I) is independently selected from the groups described above and can be the same or different. In some embodiments, R₁ is different in the repeating units of Formula (I), preferably is the trivalent group described above in some repeating units and the divalent group described above in other repeating units.

In a more preferred embodiment, R₁ and R₂ each is independently selected from

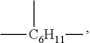

or a combination of

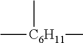

with a divalent group selected from —C₄H₈—, cyclohexylene, 1,2-cyclohexanedimethylene, 1,3-cyclohexanedimethylene, 1,4-cyclohexanedimethylene, or mixtures thereof; R₃ is —CH₃; b is 0 or 1; and —CₓH_{y}O_{z}— is a group selected from a linear or branched —C₂H₄—, —C₃H₆—, —C₄H₈—, —CH₂CH₂—O—CH₂CH₂—, —O₅H₁₀—, —C₆H₁₂- or —C₉H₁₈—; 1,2-cyclohexanedimethylene; 1,3-cyclohexanedimethylene; 1,4-cyclohexanedimethylene; cyclohexylene; or mixtures thereof.

One example of a desirable form of the epoxy resin of Formula (I) has the following structure:

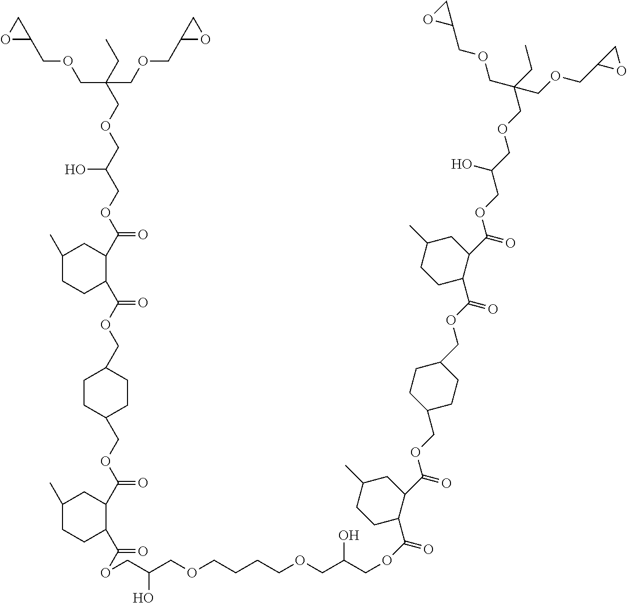 [SMILES: CCC(COCC(O)COC(=O)C1CC(C)CCC1C(=O)OCC1CCC(COC(=O)C2CC(C)CCC2C(=O)OCC(O)COCCCCOCC(O)COC(=O)C2CCC(C)CC2C(=O)OCC2CCC(COC(=O)C3CCC(C)CC3C(=O)OCC(O)COCC(CC)(COCC3CO3)COCC3CO3)CC2)CC1)(COCC1CO1)COCC1CO1]

The epoxy resin composition of the present invention may be a mixture of two or more different epoxy resins having Formula (I).

The epoxy resin composition of the present invention may have an acid value of 1.0 milligram potassium hydroxide per gram sample (mg KOH/g) or less, preferably 0.5 mg KOH/g or less, and more preferably approximately 0. The acid value, that is, the number of milligrams of KOH per gram of solid required to neutralize the acid functionality in a resin, is a measure of the amount of acid functionality. Acid value may be determined by the GB/T 2895-1982 method.

The epoxy resin composition of the present invention may have a viscosity of 5,000 millipascal·seconds (mPa·s) or higher, 10,000 mPa·s or higher, 12,000 mPa·s or higher, or even 15,000 mPa·s or higher, and at the same time, 75,000 mPa·s or lower, 70,000 mPa·s or lower, or even 65,000 mPa·s or lower. Viscosity of the epoxy resin composition may be measured by a Brookfield viscometer at 50° C. according to the ASTM D 2393-1986 method. The epoxy resin composition can also be in a semi-solid state or a solid state.

The epoxy resin composition of the present invention may have an average epoxide equivalent weight (EEW) of about 250 or higher, about 300 or higher, or even about 350 or higher, and at the same time, about 5,000 or lower, about 4,000 or lower, or even about 3,000 or lower.

The epoxy resin composition of the present invention may comprise a reaction product of (a) one or more carboxylic acid-containing half-ester compound of a cycloaliphatic saturated carboxylic acid or its anhydride with an alcohol, wherein the alcohol is an alkyl alcohol having two hydroxyl groups and/or its dimer; and (b) a polyglycidyl ether component selected from a saturated polyglycidyl ether of an alkyl alcohol, a saturated cycloaliphatic polyglycidyl ether, or mixtures thereof; wherein at least one polyglycidyl ether in the polyglycidyl ether component has an epoxy functionality larger than 2, and the molar ratio of the polyglycidyl ether component to the half-ester compound may be larger than 1 and smaller than 2.

The process of preparing the epoxy resin composition of the present invention may comprise: (i) reacting the cycloaliphatic saturated carboxylic acid or its anhydride with the alcohol to form the carboxylic acid containing half-ester compound, wherein the alcohol is an alkyl alcohol having two hydroxyl groups and/or its dimer; and (ii) reacting the half-ester compound with the polyglycidyl ether component selected from a saturated polyglycidyl ether of an alkyl alcohol, a saturated cycloaliphatic polyglycidyl ether, or mixtures thereof; wherein at least one polyglycidyl ether in the polyglycidyl ether component has an epoxy functionality larger than 2, and the molar ratio of the polyglycidyl ether component to the half-ester compound is larger than 1 and smaller than 2.

“Half-ester compound” herein refers to an ester compound containing a carboxylic acid group. The half-ester compound used to prepare the epoxy resin composition of the present invention may contain two carboxylic acid groups. The half-ester compound may comprise a mixture of two or more different half-ester compounds. These half-ester mixtures may be prepared by using a mixture of two or more carboxylic acids described above, a mixture of two or more anhydrides described above and/or a mixture of two or more alcohols described above.

The half-ester compound used to prepare the epoxy resin composition of the present invention may have the following Formula (II):

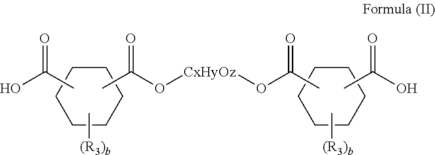

wherein x, y, z, R₃ and b are as previously defined in Formula (I). In some preferred embodiment, an ester groups and carboxylic acid groups in a cyclic ring reside in ortho-position of the cyclic ring.

The alcohol used to prepare the half-ester compound useful in the present invention has only two hydroxyl groups and can be an alkyl alcohol, a dimer of the alkyl alcohol, or mixtures thereof. Preferably, one or more alkyl alcohols are used as the alcohol component. The alcohol used to prepare the half-ester compound may be one or more linear, branched, or cyclic ring-containing alkyl alcohols, dimers thereof, or mixtures thereof.

The alcohol used to prepare the half-ester compound may have the following structure: CₓH_{y+2}O_{z+2;} wherein x, y, and z are as previously defined in Formula (I). In some embodiments, the alcohol used is a cycloaliphatic alcohol such as cyclohexanediol or cyclohexanedimethanol. Representative examples of suitable alcohols include neopentylglycol, propylene glycol, 1,6-hexanediol, ethylene glycol, 2-methyl-1,3-propanediol, diethylene glycol, cyclohexane dimethanol such as 1,4-cyclohexane dimethanol, 1,3-cyclohexane dimethanol, 1,2-cyclohexane dimethanol, 2-butyl-2-ethyl-1,3-propandiol, or mixtures thereof. In a preferred embodiment, the alcohol used in the present invention comprises 1,4-cyclohexane dimethanol.

The alcohol described above further reacts with a saturated cycloaliphatic carboxylic acid or its anhydride to form the half-ester compound. A mixture of two or more saturated cycloaliphatic carboxylic acids or carboxylic acid anhydrides may be used. The saturated cycloaliphatic carboxylic acid anhydride is particularly useful in the present invention. More preferably, dicarboxylic acid anhydrides are used to prepare the half-ester compound.

Representative examples of anhydrides useful in preparing the half-ester compound include hexahydrophthalic anhydride, methylhexahydrophthalic anhydride, or mixtures thereof. The half-ester compound used to prepare the epoxy resin composition of the present invention can be prepared by conventional methods and conditions. For example, the half-ester compound may be prepared by mixing the alcohol with the anhydride and allowing the alcohol and the anhydride to react at a temperature range of from 50° C. to 220° C. or from 90° C. to 150° C. Reaction time for the alcohol and the anhydride may vary depending on the factors such as the temperature employed and the chemical structure of the alcohol and the anhydride used. For example, generally the reaction time may be from one hour to 5 hours, or from 2 hours to 4 hours. The reaction of the alcohol with the anhydride may include an esterification catalyst known in the art. The catalyst may include, for example, basic compounds such as 4-dimethylaminopyridine; Lewis acids; p-toluenesulfonic acid; protic acids; metal salts of the protic acids; quaternary phosphonium compounds; quaternary ammonium compounds; phosphonium; arsonium adducts or complexes with suitable nonnucleophilic acids such as fluoboric acid, fluoarsenic acid, fluoantimonic acid, fluophosphoric acid, perchloric acid, perbromic acid; periodic acid; or combinations thereof. When used, the catalyst may be mixed with the alcohol and the anhydride in any order.

In preparing the half-ester compound, the alcohol and the anhydride described above are desirably mixed at a certain molar ratio, so as to achieve maximum conversion of the anhydride to the half-ester compound through the reaction of the anhydride group in the anhydride with hydroxyl groups in the alcohol. For example, the molar ratio of hydroxyl groups of the alcohol to anhydride group of the anhydride may be 1.4 or less, 1.3 or less, or even 1.2 or less, and at the same time, 0.95 or more, 0.98 or more, or even 1.0 or more.

To prepare the epoxy resin composition of the present invention, the half-ester compound described above further reacts with the polyglycidyl ether component. Carboxylic acid groups of the half-ester compound react with epoxy groups of the polyglycidyl ether component to generate a second ester linkage in the epoxy resin composition of the present invention. The polyglycidyl ether component may comprise one or more saturated polyglycidyl ethers of an alkyl alcohol, one or more saturated cycloaliphatic polyglycidyl ethers, or a mixture of at least one saturated polyglycidyl ether of an alkyl alcohol and at least one saturated cycloaliphatic polyglycidyl ether. “Polyglycidyl ether” herein refers to a multifunctional epoxy resin comprising more than one epoxy group (epoxy group also known as “oxirane group” or “epoxy functionality” or “glycidyl ether”). The polyglycidyl ether of an alkyl alcohol can generally be produced by etherification of the alkyl alcohols with epihalohydrins such as epichlorohydrin in the presence of alkali. The cycloaliphatic polyglycidyl ether herein refers to a resin having a glycidyl ether group residing on an aliphatic substituent of a ring structure and/or directly attached to the cycloaliphatic ring. Suitable saturated cycloaliphatic polyglycidyl ethers in the present invention include, for example, polyglycidyl ethers of alkyl alcohols having at least one alicyclic ring (for example, a cyclohexane ring or a cyclopentane ring).

In the polyglycidyl ether component used to prepare the epoxy resin composition of the present invention, one or more saturated polyglycidyl ethers described above have more than 2 epoxy functionalities (hereinafter referred to as “poly-functional polyglycidyl ether”). The functionality of the poly-functional polyglycidyl ether can also be three or more or four or more. Examples of suitable saturated poly-functional polyglycidyl ethers include 1,2,6-hexanetriol triglycidyl ether; glycerol triglycidyl ether; trimethylolpropane triglycidyl ether; tetraglycidyl ether of sorbitol; or mixtures thereof. In some embodiments, the polyglycidyl ether component comprises trimethylolpropane triglycidyl ether. The saturated poly-functional polyglycidyl ether may be present in the polyglycidyl ether component in an amount from 20 wt % to 100 wt %, from 30 wt % to 80 wt %, or from 40 wt % to 70 wt %, based on the total weight of the polyglycidyl ether component.

In addition to the poly-functional saturated polyglycidyl ether described above, the polyglycidyl ether component may also comprise one or more above mentioned saturated polyglycidyl ethers with two epoxy functionalities (hereinafter referred to as “diglycidyl ether”), that is, saturated diglycidyl ethers of an alkyl alcohol and/or saturated cycloaliphatic diglycidyl ethers. The saturated diglycidyl ether can be saturated diglycidyl ethers of the alkyl alcohol described above in preparing the half-ester compound. Examples of suitable saturated diglycidyl ethers include 1,5-pentanediol diglycidyl ether; 1,2,6-hexanetriol diglycidyl ether; neopentane glycol diglycidyl ether; glycerol diglycidyl ether; 1,4-butanediol diglycidyl ether (BDDGE); 1,6-hexanediol diglycidyl ether (HDDGE); 2,2-bis(4-hydroxycyclohexyl)propane diglycidyl ether; 1,4-cyclohexanedimethanol diglycidyl ether; 1,3 trans- or cis-cyclohexanedimethanol diglycidyl ether; a mixture comprising diglycidyl ether of cis-1,4-cyclohexanedimethanol and a diglycidyl ether of trans-1,4-cyclohexanedimethanol; a mixture of 1,3 and 1,4 cis- and trans-cyclohexanedimethanol diglycidyl ether; or mixtures of any of the above diglycidyl ethers. Preferred saturated diglycidyl ethers useful in the present invention is 1,6-hexanediol diglycidyl ether; 1,4-butanediol diglycidyl ether; neopentane glycol diglycidyl ether; cyclohexanedimethanol diglycidyl ether; or a mixture thereof. Preferred saturated cycloaliphatic diglycidyl ether is cyclohexanedimethanol diglycidyl ether. The cyclohexanedimethanol diglycidyl ether can comprise a diglycidyl ether of cis-1,4-cyclohexanedimethanol, a diglycidyl ether of trans-1,4-cyclohexanedimethanol, or mixtures thereof. In a preferred embodiment, the cyclohexanedimethanol diglycidyl ether used comprises a product mixture comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol. WO2009/142901, incorporated herein by reference, describes an epoxy resin composition comprising an example of a cycloaliphatic diglycidyl ether; a product mixture; and a method of isolating high purity diglycidyl ether (DGE) therefrom. Suitable cycloaliphatic diglycidyl ethers also include those described in WO2012/044442A1, incorporated herein by reference. When used, the saturated diglycidyl ether in the polyglycidyl ether component may be present in an amount from 0 wt % to 80 wt %, from 20 wt % to 70 wt %, or from 30 wt % to 60 wt %, based on the total weight of the polyglycidyl ether component.

In some embodiments, the polyglycidyl ether component useful in the present invention is a mixture of one or more saturated poly-functional polyglycidyl ethers and one or more saturated diglycidyl ethers described above. In a preferred embodiment, the polyglycidyl ether component is a mixture of trimethylolpropane triglycidyl ether and a diglycidyl ether selected from cyclohexanedimethanol diglycidyl ether, 1,4-butanediol diglycidyl ether, or a mixture thereof.

In preparing the epoxy resin composition of the present invention, the half-ester compound and the polyglycidyl ether component may be mixed together and reacted at a temperature from 90° C. to 200° C. or from 100° C. to 150° C. If desired, the half-ester compound can first be dissolved in the polyglycidyl ether component, optionally at an elevated temperature, for example, from 40° C. to 120° C.

In preparing the epoxy resin composition of the present invention, the reaction of the half-ester compound and the polyglycidyl ether component can be conducted in the presence of a catalyst to promote the reaction of the carboxylic acid groups of the half-ester compound with epoxy groups of the polyglycidyl ether component. Examples of such catalysts include basic inorganic reagents, phosphines, quaternary ammonium compounds, phosphonium compounds or mixtures thereof. When used, the catalyst may be mixed with the half-ester compound and the polyglycidyl ether component in any order. Preferably, after mixing the half-ester compound with the polyglycidyl ether component, the catalyst is added to the resultant mixture.

The reaction duration time of the half-ester compound and the polyglycidyl ether component may be generally from 5 hours to 20 hours or from 7 hours to 13 hours. The reaction time can be determined by testing the acid value of the epoxy resin composition obtained. The reaction can be stopped when the acid value of the resultant epoxy resin composition is 1 mg KOH/g or lower, 0.5 mg KOH/g or lower, or even 0.

In preparing the epoxy resin composition of the present invention, the molar ratio of the polyglycidyl ether component to the half-ester compound (hereinafter referred to as M (polyglycidyl ether component/half-ester compound)) directly relates to the repeat units and molecular weight of the epoxy resin composition. The molar ratio herein refers to the ratio of the moles of the polyglycidyl ether component (not the moles of epoxy groups) to the moles of the half-ester compound. M (polyglycidyl ether component/half-ester compound) may be >1, and at the same time, smaller than 2, or 1.5 or lower, or even 1.2 or lower.

The preparation of the epoxy resin composition may be free of, or in the presence of a solvent. When used, the solvent can reduce the viscosity of the resultant products. When present, the solvent can be used in preparing the half-ester compound and/or the reaction of the half-ester compound with the polyglycidyl ether component and/or post added to the composition. Examples of suitable solvents include ketones, esters, aliphatic ethers, cyclic ethers, aliphatic, cycloaliphatic and aromatic hydrocarbons, or mixtures thereof. Preferred examples of the solvents include toluene, butyl acetate, pentane, hexane, octane, cyclohexane, methylcyclohexane, xylene, methylethylketone, methylisobutylketone, methylcyclohexane, cyclohexanone, cyclopentanone, diethyl ether, tetrahydrofuran, 1,4-dioxane, dichloromethane, chloroform, ethylene dichloride, methyl chloroform, tert-butyl ether, dimethyl ether, or mixtures thereof. The solvent may be removed after completing the preparation of the half-ester compound and/or the reaction of the half-ester compound with the polyglycidyl ether component described above using conventional means (for example, vacuum distillation). Alternatively, the solvent may also be left in the epoxy resin composition to provide a solvent borne epoxy resin composition which may be used later, for example, in the preparation of coating.

In preparing the epoxy resin composition of the present invention, branched derivatives of the epoxy resin of Formula (I) may also be formed. For example, the epoxy resin composition may also comprise branched derivatives obtained from the reaction of epoxy group(s) if present in the repeating unit of Formula (I) and the half-ester compound described above.

The epoxy resin composition of the present invention can be cured using a curing agent having an active group being reactive with epoxy groups. Examples of suitable curing agents useful in the present invention include anhydrides, nitrogen-containing compounds such as amines and their derivatives, oxygen-containing compounds, sulfur-containing compounds and mixtures thereof. In particular, aliphatic or cycloaliphatic curing agents are used to achieve optimum weathering resistance.

Curing the epoxy resin composition of the present invention may be carried out, for example, at a temperature in a range from −10° C. up to about 300° C., from −5° C. to 250° C., about 20° C. to about 220° C., or from about 21° C. to about 25° C.; and for a predetermined period of time which may be from minutes up to hours, depending on the epoxy resin composition, curing agent, and catalyst, if used. Generally, the time for curing or partially curing the epoxy resin composition may be from 2 seconds to 24 days, from 0.5 hour to 7 days, or from one hour to 24 hours. It is also operable to partially cure the epoxy resin composition of the present invention and then complete the curing process at a later time. Advantageously, the epoxy resin composition can be cured by an amine curing agent at ambient temperature.

The epoxy resin composition of the present invention may be used in various applications, including for example, coatings, adhesives, electrical laminates, structural laminates, composites, filament windings, moldings, castings, encapsulations, pultrusion and any application where weathering resistance is desirable.

The curable coating composition of the present invention comprises the epoxy resin composition described above and an amine curing agent. The amine curing agent may comprise an aliphatic amine or its adduct, a cycloaliphatic amine or its adduct, or any combination thereof. The amine can be a diamine, a polyamine, or mixtures thereof. Examples of suitable amines useful in the present invention include an aliphatic amine such as ethylenediamine (EDA); diethylenetriamine (DETA); triethylenetetramine (TETA); trimethyl hexane diamine (TMDA); tetraethylenepentamine; hexamethylenediamine (HMDA); 1,6-hexanediamine; N-(2-aminoethyl)-1,3-propanediamine; N,N′-1,2-ethanediylbis-1,3-propanediamine; dipropylenetriamine or mixtures thereof; cycloaliphatic amine such as isophorone diamine (IPDA); 4,4′-diaminodicyclohexylmethane (PACM); 1,2-diaminocyclohexane (DACH); 1,4-cyclohexanediamine; bis(aminomethyl)norbornane or mixtures thereof; heterocyclic amine such as piperazine, aminoethylpiperazine (AEP); polyether amine such as bis(aminopropyl)ether; polyamide; their adducts; and mixtures thereof. Preferred examples of amines useful in the present invention include AEP or its adduct; IPDA or its adduct; DETA or its adduct; PACM or its adduct; DACH or its adduct; polyether amine or its adduct; polyamide or its adduct; or combinations thereof. The amine curing agent may comprise one or more adducts of the aliphatic and/or cycloaliphatic amines, for example, adducts of IPDA and BDDGE, adducts of IPDA and aliphatic acids, adducts of IPDA and cyclohexanedimethanol (CHDM) epoxy resin, and mixtures thereof. The amine curing agent desirably comprises an adduct of the aliphatic and/or cycloaliphatic amine with the epoxy resin composition of the present invention. The amine curing agent may optionally comprise one or more accelerators and/or catalysts. The amine curing agent may be used in a sufficient amount to cure the curable coating composition. A molar ratio of total active hydrogen functionality of the amine curing agent to total epoxy functionality of total epoxy resins in the curable coating composition may be generally from 0.5:1 to 1.3:1, from 0.6:1 to 1.2:1, or from 0.8:1 to 1:1.

The curable coating composition of the present invention can also contain one or more extenders and/or pigments. The extenders and/or pigments may be ceramic materials, metallic materials including metalloid materials. Suitable ceramic materials include for example metal oxides such as zinc oxide, titanium dioxide, metal nitrides (for example, boron nitride), metal carbides, metal sulfides (for example, molybdenum disulfide, tantalum disulfide, tungsten disulfide, and zinc sulfide), metal silicates (for example, aluminum silicates and magnesium silicates such as vermiculite), metal borides, metal carbonates, or mixtures thereof. These particles can be surface treated or untreated. When used, the combined amount of extenders and pigments may be, based on the total weight of the curable coating composition, from 5 wt % to 90 wt % or from 10 wt % to 80 wt %.

The coating composition of the present invention may further comprise an additional epoxy resin, which has different structure from the epoxy resin composition of the present invention. The additional epoxy resin may be any type of epoxy resins containing one or more reactive epoxy groups that is known in the coating art. The additional epoxy resin may include mono-functional epoxy resins, multi- or poly-functional epoxy resins, and combinations thereof. Generally, the additional epoxy resin, if present, may be used in an amount that can maintain the previously stated weathering resistance, and drying property. Preferably, the coating composition of the present invention is substantially free from aromatic epoxy resins such as bisphenol A epoxy resins which may compromise the weathering resistance of the resultant coating films. Examples of suitable additional epoxy resins include the saturated polyglycidyl ether of an alkyl alcohol described above, the saturated cycloaliphatic polyglycidyl ether described above, any other aliphatic and cycloaliphatic epoxy resins known in the art, or combinations thereof. When used, the additional epoxy resin may be present, based on the total weight of epoxy resins in the coating composition, in an amount less than 40 wt %, less than 30 wt %, or even less than 10 wt %.

In addition to the foregoing components, the curable coating compositions of the present invention may further comprise any one or combination of the following additives: anti-foaming agents, plasticizers, anti-oxidants, light stabilizers, ultraviolet (UV) absorbers, UV-blocking compounds, UV stabilizer, and flow control agents. When used, these additives may be present in a combined amount of, from 0.001 wt % to 10 wt % or from 0.01 wt % to 5 wt %, based on the total weight of the curable coating composition.

All components mentioned above present in the curable coating composition of the present invention may generally be dissolved or dispersed in an organic solvent. The solvent in the coating composition may include the solvent described above in preparing the epoxy resin composition; alcohols such as n-butanol, glycols such as ethylene glycol, propylene glycol and butyl glycol; glycol ethers such as propylene glycol monomethyl ether and ethylene glycol dimethyl ether; or mixtures thereof. The organic solvent may be present, based on the total weight of the curable coating composition, in an amount from 5 wt % to 60 wt %, from 10 wt % to 50 wt %, or from 20 wt % to 40 wt %.

Preparation of the curable coating composition of the present invention may be achieved by admixing the epoxy resin composition and the amine curing agent, preferably dissolved in the solvent. Other optional components including, for example, extenders and/or pigments and/or other optional additives may also be added, as described above. Components in the curable coating composition may be mixed in any order to provide the curable coating composition of the present invention. Any of the above-mentioned optional components may also be added to the composition during the mixing or prior to the mixing to form the composition.

The curable coating composition of the present invention can be applied by conventional means including brushing, dipping, rolling and spraying. The curable coating composition is preferably applied by spraying. The standard spray techniques and equipment for air spraying, airless spraying, and electrostatic spraying, such as electrostatic bell application, and either manual or automatic methods can be used.

The curable coating composition of the present invention can be applied to, and adhered to, various substrates. Examples of substrates over which the curable coating composition may be applied include wood, concrete, metals, plastic, glass, foams, or elastomeric substrates. The substrates typically contain a primer coat. Examples of suitable primers include epoxy primers and PU primers.

The curable coating composition of the present invention is suitable for various coating applications, such as marine coatings, protective coatings, automotive coatings, wood coatings, coil coatings, concrete coatings, and plastic coatings. The curable coating composition is particularly suitable for topcoat applications.

The curable coating composition of the present invention can be cured under the conditions as described above with reference to the epoxy resin composition. In a preferred embodiment, the curable coating composition is cured at ambient temperature. The curable coating composition of the present invention has a fast drying speed, for example, a tack-free time of 5 hours or less, 4.5 hours or less, 4 hours or less, or even 3.5 hours or less, at ambient temperature as determined by the ASTM D 5895 method.

Upon curing, the curable coating composition of the present invention forms a coating film that has one or more the following properties:

(1) Satisfactory weathering resistance to achieve gloss retention of at least 70% after at least 450 hours of artificial weathering testing according to the ASTM G154-06 method. In a preferred embodiment, the coating film achieves gloss retention of at least 70% after at least 500 hours of the testing, after at least 600 hours of the testing, after at least 700 hours of the testing, or even after at least 900 hours of the testing;

(2) Satisfactory weathering resistance to achieve a change of b value (“Δb”) less than 1.5 after at least 450 hours of artificial weathering testing according to the ASTM G154-06 method. In a preferred embodiment, the coating film achieves Δb less than 0.6 after at least 500 hours of the testing, after at least 600 hours of the testing, after at least 700 hours of the testing, or even after at least 900 hours of the testing; and

(3) Better adhesion to an epoxy primer coat than a conventional PU topcoat when primer and topcoat compositions are applied and/or cured at ambient temperature or 5° C. or lower, showing 4B or higher rating according to the ASTM D 3359 method. In addition, a time period between applying an epoxy primer and the coating composition of the present invention can be shorter than that of between applying the same epoxy primer and a conventional PU topcoat composition.

### EXAMPLES

The following examples illustrate embodiments of the present invention. All parts and percentages in the examples are by weight unless otherwise indicated. The following materials are used in the examples:

Methyl hexahydrophthalic anhydride (“MHHPA”) is available from Changzhou Bolin Chemical Company.

1,4-Butanediol diglycidyl ether (“BDDGE”) and trimethylolpropane triglycidyl ether (“TMPTGE”) are both available from Anhui Hengyuan Chemical Co., Ltd.

Isophorone diamine (“IPDA”) is available from BASF.

Diethylenetriamine (“DETA”) and aminoethylpiperazine (“AEP”) are both available from The Dow Chemical Company.

DESMOPHEN™ A 365 BA/X resin, available from Bayer, is a hydroxyl-bearing polyacrylate.

Titanium dioxide (TiO₂) is available from DuPont.

INTERGARD™ 787 primer is an epoxy primer available from International Paint.

TINUVIN™ 292 light stabilizer is available from BASF.

CRAYVALLAC™ Ultra, available from Cray Valley Company, is a polyamide type thixotropic agent.

Butyl CELLOSOLVE™ Solvent, available from Dow Chemical Company, is ethylene glycol monobutyl ether type solvent (CELLOSOLVE is a trademark of The Dow Chemical Company).

BYK™ 182, available from BYK Chemical Company, is a block copolymer and is used as dispersant.

BYK 085, available from BYK Chemical Company, is a polysiloxane and is used as defoamer.

DESMODUR™ N 75 polyisocyanate is an aliphatic polyisocyanate and is available from Bayer.

Cyclohexanedimethanol (“CHDM”) is available from Jiangsu Kangheng Chemical.

Ethyltriphenylphosphonium iodide (“ETPPI”), available from The Dow Chemical Company, is a quaternary phosphonium salt catalyst.

Cyclohexanedimethanol epoxy resin (“CHDM Epoxy Resin”) is prepared for use herein by the method described herein below.

D.E.R.™ 736 epoxy resin (D.E.R. is a trademark of The Dow Chemical Company), available from The Dow Chemical Company, is short chain polyglycol di-epoxide liquid resin and has an EEW of 190.

VORANOL™ CP 260 polyol, available from The Dow Chemical Company, is a polyether triol and a glycerine initiated polyoxypropylene polyol having a molecular weight of about 260 (VORANOL is a trademark of The Dow Chemical Company).

UNOXOL™ Diol, available from The Dow Chemical Company, is a mixture of cis-, trans-1,3- and 1,4-cyclohexanedimethanol (UNOXOL is a trademark of The Dow Chemical Company).

ERL™ 4221 epoxy resin (ERL is a trademark of The Dow Chemical Company), available from The Dow Chemical Company, has an EEW of 126 and has the following structure:

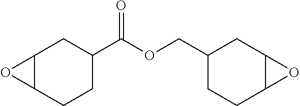 [SMILES: O=C(OCC1CCC2OC2C1)C1CCC2OC2C1]

The following standard analytical equipment and methods are used in the Examples.

### Measurement of Acid Value

The acid value is measured in accordance with the GB/T 2895-1982 method. The acid value for a resin is defined as the mg KOH per gram of resin necessary to neutralize a resin in a simple titration using thymol blue as a color indicator. KOH is conveniently 0.1 N (mole per liter) in ethanol solution. The resin was dissolved in mixed solvents of toluene and ethanol (2:1 in volume).

### Drying Property

A BYK drying timer is used to record the tack-free time of a coating composition according to the ASTM D 5895 method. The coating composition to be evaluated is coated on a glass panel with a wet film thickness of 150 μm, and then the coated glass panel is put on to the BYK drying timer for drying at ambient temperature.

### Adhesion Test

The adhesion between a primer coat and a topcoat is evaluated by cross hatch according to the ASTM D 3359 method. Part B and Part A of INTERGARD 787 epoxy primer, a commonly used primer in M&PC industry, are mixed at a volume ratio of 3:1 and are sprayed onto a blast-cleaned plate using an air spray method to form an epoxy primer coat on the plate. After one hour, an epoxy or PU topcoat composition to be evaluated is sprayed onto the epoxy primer coat. After curing at 0° C. for 7 days or curing at ambient temperature for 7 day, respectively, the adhesion between the epoxy primer coat and the epoxy or PU topcoat is tested. The obtained topcoat has an average thickness of 60 μm. The test results is designated as 0B, 1B, 2B, 3B, 4B and 5B, among which 5B indicates the best adhesion between the primer coat and the topcoat, and 0B indicates the worst adhesion.

### Artificial Weathering Test

The artificial weathering test is conducted according to the ASTM G154-06 method. The test includes the following repeating cycles: UV irradiation at 60±3° C. for 4 hours, and condensation at 50±3° C. for 4 hours.

INTERGARD 787 epoxy primer is sprayed onto a blast-cleaned plate and cured at ambient temperature for one day to form a dry film with a thickness of 60-80 μm. Then, a topcoat composition to be evaluated is sprayed on the resultant primer and cured at ambient temperature for 7 days to form a dry film with a thickness of 50-60 μm. Gloss values at 60 degrees (°) and b values of the obtained coated panels before the artificial weathering test and after a certain time period of the artificial weathering test are evaluated according to the ASTM D523 method using a BYK Micro-Tri-Gloss meter.

### Flexibility

A coating composition to be evaluated is directly sprayed onto a tinplate and cured at ambient temperature for 7 days to form a coating film with an average thickness of 30 μm. Conical flexibility test is conducted to evaluate the ability of the coating film to resist cracking according to the ASTM D 522 method. If no cracking on the film at radium of 3.3 mm after the test is visible to the naked eye, it indicates that the coating film has good flexibility.

### Impact Resistance

A coating composition to be evaluated is directly sprayed onto a tinplate and cured at ambient temperature for 7 days to form a coating film with an average thickness of 30 microns. The impact resistance of the coating film is evaluated according to the ASTM 2794 method.

### Epoxide Equivalent Weight (EEW) Analysis

A standard titration method is used to determine percent epoxide in various epoxy resins. The titration method used is similar to the method described in Jay, R.R., “Direct Titration of Epoxy Compounds and Aziridines”, Analytical Chemistry, 36, 3, 667-668 (March 1964). In the present adaptation of this method, the carefully weighed sample (sample weight ranges from 0.17-0.25 gram) was dissolved in dichloromethane (15 mililiter (mL)) followed by the addition of tetraethylammonium bromide solution in acetic acid (15 mL). The resultant solution treated with 3 drops of crystal violet indicator (0.1% wt/vol in acetic acid) was titrated with 0.1 N perchloric acid in acetic acid on a Metrohm 665 Dosimat titrator (Brinkmann). Titration of a blank consisting of dichloromethane (15 mL) and tetraethylammonium bromide solution in acetic acid (15 mL) provided correction for solvent background. Percent epoxide and EEW are calculated using the following equations:

% Epoxide=[(mL titrated sample)−(mL titrated blank)]×(0.4303)/(gram sample titrated) EEW=43023/[% Epoxide]

### Preparation of CHDM Epoxy Resin

### A. Epoxidation of 1,4-Cyclohexanedimethanol (1,4-CHDM)

A 5 liter (L), 4 neck, glass, round bottom reactor was charged with cis- and trans-1,4-CHDM (432.63 gram (g), 3.0 moles, 6.0 hydroxyl equivalent), epichlorohydrin (1110.24 g, 12.0 moles, 2:1 epichlorohydrin: cis- and trans-1,4-CHDM hydroxyl equivalent ratio), toluene (1.5 L), and 60% aqueous benzyltriethylammonium chloride (54.53 g, 32.72 g active, 0.1436 mole) in the indicated order. The reactor was additionally equipped with a condenser (maintained at 0° C.), a thermometer, a Claisen adaptor, an overhead nitrogen inlet (1 liter per minute (LPM) N₂ used), and a stirrer assembly (Teflon™ paddle, glass shaft, variable speed motor). Sodium hydroxide (360.0 g, 9.0 moles) dissolved in deionized (DI) water (360 g) was added dropwise to the reactor. The addition progressed for 250 minutes with reaction temperature of the reaction mixture held in range of 30 to 32.5° C. After 950 minutes of post reaction, the temperature in the reactor had declined to 26.5° C. DI water (1000 g) was added to the stirred reactor to dissolve precipitated salts. After 30 minutes stirring the biphasic mixture was separated. The water saturated organic phase recovered weighed 2565.14 g.

The organic layer was reloaded into the reactor along with fresh 60% aqueous benzyltriethylammonium chloride (27.26 g, 16.36 g active, 0.0718 mole). Sodium hydroxide (180 g, 4.5 moles) DI water (180 g) was added dropwise over 2 hours. After 958 minutes of post reaction, DI water (453 g) was added to the stirred reactor to dissolve precipitated salts. After 30 minutes stirring the biphasic mixture was separated. The water saturated organic phase recovered weighed 2446.24 g.

The organic layer was reloaded into the reactor along with fresh 60% aqueous benzyltriethylammonium chloride (13.64 g, 8.18 g active, 0.0359 mole). Sodium hydroxide (90 g, 2.25 moles) dissolved in DI water (90 g) was added dropwise over 100 minutes. After 980 minutes of post reaction, DI water (185 g) was added to the stirred reactor to dissolve precipitated salts. After 30 minutes stirring, the biphasic mixture was separated. The water saturated organic phase recovered weighed 2389.76 g. The organic layer was then washed twice with DI water (800 mL each time). The hazy organic solution was dried with anhydrous sodium sulfate. Volatiles were removed by rotary evaporation (bath temperature of 100° C.) to a final vacuum of 0.44 mm Hg. A total of 750.54 g of yellow colored, transparent 1,4-CHDM liquid epoxy resin product was recovered after completion of the rotary evaporation. Gas chromatography (GC) analysis revealed the presence of 0.13 area % lights, 0.26 area % cis- and trans-1,4-CHDM, 3.85 area % monoglycidyl ethers (MGE), 0.23 area % of three minor components associated with the diglycidyl ether (DGE) peaks, 74.98 area % DGE, and 20.55 area % oligomers.

### Example (Ex) 1

### Epoxy Resin

6.0 moles MHHPA and 3.0 moles CHDM were charged into a reactor to form a mixture. The mixture was heated to 130° C. and maintained at 130° C. with stirring for about 3 hours. The mixture in the reactor was tested to determine its acid value intermittently at various time intervals. When the acid value of the mixture approached about 230 mg KOH/g, the reactor was cooled down to ambient temperature and a half-ester compound was obtained. 1.0 mole TMPTGE and 3.0 moles CHDM Epoxy Resin prepared above were then charged into the reactor. After the half-ester compound was completely dissolved at 100° C., 300 ppm ETPPI catalyst was added. The reaction temperature was slowly raised to 120° C. and maintained at 120° C. for several hours. When the acid value of the resultant compound approached 0.5 mg KOH/g or lower, the reaction was stopped. The resulting epoxy resin composition obtained from the above procedure has an EEW of about 1000. The obtained epoxy resin of Ex 1 was analyzed by gel permeation chromatography (GPC) analysis. The GPC results demonstrated that the epoxy resin of Ex 1 was a polymer with broad molecular weight distribution: a weight average molecular weight (M_{w}) of 16,316 and a polydispersity index (PDI) of 9.78 according to GPC calibrated with a Polystyrene (PS) standard.

### Ex 2

### Epoxy Resin

8.0 moles MHHPA and 4.0 moles CHDM were charged into a reactor to form a mixture. The mixture in the reactor was heated to 130° C. and maintained at 130° C. with stirring for about 3 hours. The mixture was tested to determine its acid value intermittently at various time intervals. When the acid value of the mixture approached about 230 mg KOH/g, the reactor was cooled down and a half-ester compound was obtained. 5.0 moles TMPTGE was then charged into the reactor. After the half-ester compound was completely dissolved at 100° C., 300 ppm ETPPI catalyst was added. The reaction temperature was heated to 120° C. and maintained at 120° C. for several hours. When the acid value of the resultant compound approached 0.5 mg KOH/g or lower, the reaction was stopped. The resulting epoxy resin composition obtained from the above procedure has an average EEW of 600. The obtained epoxy resin of Ex 2 was analyzed by GPC analysis. The GPC results demonstrated that the epoxy resin of Ex 2 was a polymer with broad molecular weight distribution: a M_{w} of 13,734 and a PDI of 9.73 according to GPC calibrated with a PS standard.

### Ex 3

### Epoxy Resin

4.0 moles MHHPA and 2.0 moles CHDM were charged into a reactor to form a mixture. The mixture in the reactor was heated to 130° C. and maintained at 130° C. with stirring for about 3 hours. The mixture was tested to determine its acid value intermittently at various time intervals. When the acid value of the mixture approached about 230 mg KOH/g, the reactor was cooled down and a half-ester compound was obtained. 2.2 moles TMPTGE and 0.9 moles BDDGE were then charged into the reactor. After the half-ester compound was completely dissolved at 100° C., 300 ppm ETPPI catalyst was added. The reaction temperature was heated to 120° C. and maintained at 120° C. for several hours. When the acid value of the resultant compound approached 0.5 mg KOH/g or lower, the reaction was stopped. The resulting epoxy resin composition obtained from the above procedure has an average EEW of 500. The obtained epoxy resin of Ex 3 was analyzed by GPC analysis. The GPC results demonstrated that the epoxy resin of Ex 3 was a polymer with broad molecular weight distribution: a M_{w} of 11,059 and a PDI of 8.12 according to GPC calibrated with a PS standard.

### Exs 4-6

### Coating Compositions

Coating compositions of Exs 4-6 were prepared based on formulations described in Table 1. Part A was prepared by mixing and dispersing all components with a high speed disperser. Part A was then mixed with Part B and stirred for about 30 minutes to form a topcoat composition. The topcoat composition was then sprayed onto a blast-cleaned plate coated with primer using an air spray method. The resultant panels of epoxy topcoat were gained.

TABLE 1

| Epoxy topcoat compositions, weight parts | | Ex 4 | Ex 5 | Ex 6 |
|---|---|---|---|---|
| Part A | Epoxy resin of Ex 1 | 36.5 | | |
| | Epoxy resin of Ex 2 | | 37.98 | |
| | Epoxy resin of Ex 3 | | | 35.25 |
| | Butyl acetate | 12.7 | 9.49 | 16.37 |
| | TiO₂ | 36.5 | 22.31 | 21.80 |
| | CRAYVALLAC Ultra | 0.9 | | |
| | BYK 182 | 1.1 | | |
| | BYK 085 | 0.1 | | |
| | Butanol | | 9.10 | 5.46 |
| | Butyl CELLOSOLVE solvent | | 9.10 | 5.46 |
| Part B | AEP | 1.5 | 2.40 | 2.81 |
| | Xylene | 9.1 | | |
| | Iso-butanol | 3.0 | | |
| | Butyl acetate | | | 6.74 |
| | Butanol | | 4.81 | 2.25 |
| | Butyl CELLOSOLVE solvent | | 4.81 | 2.25 |

### Comparative (Comp) Ex A

A two-pack PU coating composition shown below is widely used in M&PC market for producing a topcoat and can meet high performance topcoat standard. Part A and Part B were mixed and stirred for about 30 minutes to form a PU topcoat composition. The PU topcoat composition was then sprayed onto a blast cleaned plate with primer using air spray method.

| PU topcoat composition | | Weight parts |
|---|---|---|
| Part A | DESMOPHEN A 365 BA/X resin | 41.7 |
| | Xylene | 11.9 |
| | TiO₂ | 23.5 |
| | Butyl acetate | 7.0 |
| | TINUVIN 292 light stabilizer | 0.2 |
| Part B | DESMODUR N 75 aliphatic polyisocyanate | 15.8 |

### Comp Ex B

23.62 g of MHHPA and 17.8 g of VORANOL CP 260 polyether polyol were charged into a reactor and heated to 130° C. After 3 hour at 130° C., the acid value reached about 190 mg KOH/g and a half-ester compound was obtained. 58.8 g of D.E.R. 736 resin was charged into the resultant half-ester compound. After the half-ester compound was completely dissolved in D.E.R. 736 resin at 90° C., 1500 ppm ETPPI was then added into the reactor, and the reaction temperature was slowly raised to 125° C. The reaction was stopped when the acid value of the resultant compound was below 1 mg KOH/g. The resulting comparative epoxy resin composition obtained from the above procedure had an average EEW of about 590.

100 g of the comparative epoxy resin composition obtained above was dissolved into 12 g of butyl acetate to form Part A. Part B was a hardener formulation, which was a blend of AEP and butyl acetate at a weight ratio of 70/30. Part B was mixed into Part A at a stoichiometric ratio of 1:1 to form a coating composition of this Comp Ex B.

### Comp Ex C

2.0 moles MHHPA and 1.0 mole UNOXOL Diol were charged into a reactor and heated to 130° C. The resultant mixture in the reactor was heated to 130° C. with stirring for about 3 hours. At time intervals, the reaction mixture was tested to determine the acid value of the reaction mixture. When the acid value approached about 190 mg KOH/g, the reactor was cooled down and a half-ester compound was obtained. 2.0 moles BDDGE was charged into the resulted half-ester compound. After the half-ester compound was completely dissolved in BDDGE at 90° C., 300 ppm ETPPI was added and the reaction temperature was slowly raised to 110° C. When the acid value reached below 1 mg KOH/g, the reaction was stopped. The resulting comparative epoxy resin composition obtained from the above procedure had an average EEW of about 560.

100 g of the comparative epoxy resin composition obtained above was dissolved in 12 g of n-Butyl acetate to form part A. Part B was a hardener formulation, which was a blend of AEP and butyl acetate at a weight ratio of 70/30. Part B was mixed into Part A at a stoichiometric ratio of 1:1 to form a coating composition of this Comp Ex C.

### Comp Ex D

4.0 moles MHHPA and 2.0 moles CHDM were charged into a reactor to form a mixture. The mixture in the reactor was heated to 130° C. and maintained at 130° C. with stirring for about 3 hours. The mixture was tested to determine its acid value intermittently at various time intervals. When the acid value of the mixture approached about 230 mg KOH/g, the reactor was cooled down and a half-ester compound was obtained. 3.0 moles ERL 4221 epoxy resin was then charged into the reactor. After the half-ester compound was completely dissolved at 120° C., 300 ppm ETPPI catalyst was added. The reaction temperature was heated to 120° C. and maintained at 120° C. for several hours. Butyl acetate solvent was added into the reactor to decrease the viscosity during the reaction. When the acid value of the resultant compound approached 1.0 mg KOH/g or lower, the reaction was stopped. The resulting comparative epoxy resin obtained from the above procedure has an average EEW of about 1,500.

The comparative epoxy resin composition obtained above was mixed with AEP at a stoichiometric ratio of 1:1 to form a coating composition of this Comp Ex D.

Drying properties of the above coating compositions and properties of coating films formed from the coating compositions were evaluated according to the testing methods described above and reported in Table 2. As shown in Table 2, the coating compositions of Exs 4-6 had a tack-free time of 2.7 hours, 2 hours, and 2 hours, at ambient temperature, respectively. In contrast, the coating compositions of Comp Exs B-D all showed a much longer tack-free time at ambient temperature than the inventive coating compositions. The coating composition of Comp Ex D was still in a liquid state and did not gel even after 7-day storage at ambient temperature. It indicates that the epoxy resin in the coating composition of Comp Ex D was not able to be cured by an amine hardener at ambient temperature. The coating compositions of Comp Exs B-D could not meet industrial requirements of being tack-free in less than 5 hours.

TABLE 2

| Coating Composition | Tack-Free Time |
|---|---|
| Ex 4 | 2.7 hours |
| Ex 5 | 2.0 hours |
| Ex 6 | 2.0 hours |
| Comp Ex B | Sticky after 3 weeks |
| Comp Ex C | 7.5 hours |
| Comp Ex D | in a liquid state and not gel after 7-day storage at |
| | ambient temperature |

Table 3 shows the gloss and b values of coating films made from Ex 4 during the artificial weathering test. After around 500 hours exposure/cyclic test, the gloss retention of the film was around 70% (the initial gloss value was about 84) and Δb of the film was 1.32 (the initial b value was 1.59). It indicates that the epoxy resin of Ex 1 has good weathering resistance.

TABLE 3
Epoxy coating composition of Ex 4

| Exposure time (hour) | Gloss of epoxy topcoat (60°) | b value |
|---|---|---|
| 0 | 84.1 | 1.59 |
| 143 | 81.3 | 2.19 |
| 239 | 80.5 | 2.33 |
| 311 | 77.9 | 2.46 |
| 455 | 65.4 | 2.42 |
| 503 | 61.1 | 2.91 |
| 568 | 50.6 | 2.92 |
| 664 | 38.0 | 2.99 |

Table 4 shows the gloss and b values of coating films made from Ex 5 during the artificial weathering test. After around 900 hours exposure/cyclic test, the gloss retention of the film was about 70% (the initial gloss value was about 89.4), and Δb of the film was 0.88 (the initial b value was 1.07). It indicates that the epoxy resin of Ex 2 has good weathering resistance.

TABLE 4
Epoxy coating composition of Ex 5

| Exposure time (hour) | Gloss of epoxy topcoat (60°) | b value |
|---|---|---|
| 0 | 89.4 | 1.07 |
| 236 | 88.0 | 1.39 |
| 336 | 89.4 | 1.51 |
| 461 | 87.6 | 1.55 |
| 618 | 85.7 | 1.82 |
| 766 | 72.9 | 1.81 |
| 859 | 66.9 | 1.95 |
| 931 | 59.8 | 1.95 |
| 979 | 55.4 | 1.96 |

Table 5 shows the gloss and b values of coating films made from Ex 6 during the artificial weathering test. After exposure for about 1200 hours, the gloss retention of the film was around 70% (the initial gloss was about 93), and Δb of the film was 0.8 (the initial b value was 1.28). It indicates that the epoxy resin of Ex 3 has good weathering resistance.

In particular, the coating films made from the coating compositions of Exs 4-6 achieved the above weathering resistance without the requirement of using UV stabilizers or UV absorbers.

TABLE 5
Epoxy coating composition of Ex 6

| Exposure time (hour) | Gloss of epoxy topcoat (60°) | b value |
|---|---|---|
| 0 | 92.9 | 1.28 |
| 336 | 91.5 | 1.61 |
| 461 | 88.8 | 1.78 |
| 618 | 87.6 | 1.85 |
| 766 | 84 | 2.15 |
| 859 | 82.5 | 2.04 |
| 931 | 78.9 | 2.24 |
| 979 | 79.1 | 2.29 |
| 1075 | 74.7 | 2.2 |
| 1147 | 70 | 2.3 |
| 1459 | 43.7 | 2.44 |

The cross-hatch adhesion between an epoxy primer coat and a topcoat was evaluated according to the Adhesion Test method described above. The time period between applying an epoxy primer and a topcoat composition was one hour for the adhesion test. The topcoat compositions were cured at two different conditions: 0° C. for 7 days, or ambient temperature for 7 days. The PU topcoats made from Comp Ex A cured at the above two different conditions both showed 2B rating in the adhesion test. In contrast, the epoxy topcoats made from Ex 4 cured at the two different conditions showed 4B (ambient temperature for 7 days) and 5B rating (0° C. for 7 days), respectively. The results of the adhesion test showed that the epoxy topcoats made from the coating composition of Ex 4 had better adhesion to the epoxy primer coat than the PU topcoat made from Comp Ex A. It also indicates that the time period between applying an epoxy primer and the coating composition comprising the epoxy resin of Ex 1 can be shorter than commonly used in the coating industry where an epoxy primer is usually left overnight before applying a PU topcoat composition, which can reduce waiting time and increase efficiency.

Conical flexibility properties of coating films were also evaluated according to the test method described above. Coating films made from the coating compositions of Exs 4-6 had no cracking at a radium of 3.3 mm visible to the naked eye, which indicates that the coating films have good flexibility.

In addition, the impact resistance of coating films was evaluated according to the test method described above. The coating film made from the coating composition of Ex 4 also had a direct impact strength and a reverse impact strength of both around 45.4 cm*kg (100 cm*pound), which indicates that the coating films have good impact resistance.

What is claimed is:

1. An epoxy resin composition, comprising at least one epoxy resin having the following Formula (I): 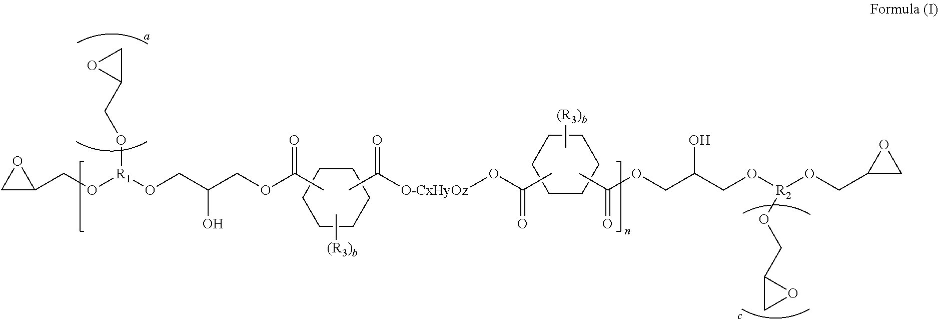
wherein x is an integer from 2 to 15; y is an integer from 4 to 30; z is 0 or 1; a is an integer from 0 to 2, c is an integer from 0 to 2, provided that a+c≠0; b is an integer from 0 to 4; R₁ and R₂ each is independently a saturated C₂ to C₂₀ aliphatic hydrocarbon group, a saturated C₅ to C₂₀ cycloaliphatic hydrocarbon group, or a mixture thereof; R₃ is a C₁ to C₆ alkyl group; and n is an integer from 1 to 60.

2. The epoxy resin composition of claim 1, wherein z is 0 and —CₓH_{y}O_{z}— is a C₆ to C₁₀ cycloalkylene group, a C₂ to C₉ aliphatic hydrocarbon group, or a mixture thereof.

3. The epoxy resin composition of claim 1, wherein R₁ and R₂ each is independently a C₆ to C₁₀ cycloalkylene group, a C₂ to C₈ aliphatic hydrocarbon group, or a mixture thereof.

4. The epoxy resin composition of claim 1, wherein R₁ and R₂ each is independently selected from 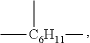
or its combination with a divalent group selected from —C₄H₈—, cyclohexylene, 1,2-cyclohexanedimethylene, 1,3-cyclohexanedimethylene, 1,4-cyclohexanedimethylene, or mixtures thereof; R₃ is —CH₃; b is 0 or 1; and —CxHyOz- is a group selected from a linear or branched —C₂H₄—, —C₃H₆—, —CH₂CH₂—O—CH₂CH₂—, —O₆H₁₀—, —O₆H₁₂— or —C₉H₁₈—; 1,2-cyclohexanedimethylene; 1,3-cyclohexanedimethylene; 1,4-cyclohexanedimethylene; cyclohexylene; or mixtures thereof.

5. The epoxy resin composition of claim 1, having an acid value of one milligram potassium hydroxide per gram or less.

6. A process of preparing the epoxy resin composition of claim 1, comprising:
(i) reacting a cycloaliphatic saturated carboxylic acid or its anhydride with an alcohol to form a carboxylic acid-containing half-ester compound, wherein the alcohol is an alkyl alcohol having two hydroxyl groups and/or its dimer; and
(ii) reacting the half-ester compound with a polyglycidyl ether component selected from a saturated polyglycidyl ether of an alkyl alcohol, a saturated cycloaliphatic polyglycidyl ether, or mixtures thereof; wherein at least one saturated polyglycidyl ether in the polyglycidyl ether component has an epoxy functionality more than 2; and the molar ratio of the polyglycidyl ether component to the half-ester compound is larger than 1 and smaller than 2.

7. The process of claim 6, wherein the molar ratio of the polyglycidyl ether component to the half-ester compound is larger than 1 and no more than 1.5.

8. The process of claim 6, wherein the alcohol used to form the half-ester compound is a cycloaliphatic alcohol.

9. The process of claim 6, wherein the alcohol used to form the half-ester compound is selected from neopentylglycol, propylene glycol, 1,6-hexanediol, ethylene glycol, 2-methyl-1,3-propanediol, diethylene glycol, 1,2-cyclohexane dimethanol, 1,3-cyclohexane dimethanol, 1,4-cyclohexane dimethanol, 2-butyl-2-ethyl-1,3-propandiol, or mixtures thereof.

10. The process of claim 6, wherein the polyglycidyl ether component further comprises a saturated diglycidyl ether of an alkyl alcohol, a saturated cycloaliphatic diglycidyl ether, or mixtures thereof.

11. The process of claim 6, wherein the saturated polyglycidyl ether having an epoxy functionality more than 2 is trimethylolpropane triglycidyl ether.

12. The process of claim 6, wherein the half-ester compound is prepared by reacting the alcohol with the anhydride at a molar ratio of hydroxyl groups of the alcohol to anhydride group of the anhydride ranging from 0.95 to 1.4.

13. The process of claim 6, wherein the half-ester compound reacts with the polyglycidyl ether component in the presence of a catalyst selected from phosphines, quaternary ammonium compounds, phosphonium compounds, or mixtures thereof.

14. A curable coating composition comprising: the epoxy resin composition of claim 1, and an amine curing agent selected from an aliphatic amine or its adduct, a cycloaliphatic amine or its adduct, or mixtures thereof.

15. The curable coating composition of claim 14, wherein the coating composition is substantially free from aromatic epoxy resins.
